(19) United States
(12) Patent Application Publication
(10) Pub. No.: US 2005/0276037 A1
(43) Pub. Date: Dec. 15, 2005

(54) Luminous device on goggle

(76) Inventor: Tzong-Fuh Kuo, Hsin Juang City (TW)

Correspondence Address: PRO-TECHTOR INTERNATIONAL SERVICES, 20775 Norada Court, Saratoga, CA, 95070-3018, US

(21) Appl. No.: 10/867,066

(22) Filed: Jun. 12, 2004

(51) Int. Cl. F21V 21/084

(52) U.S. Cl. 362/105; 362/800; 362/267

(57) ABSTRACT

The present invention relates to a waterproof luminous device on a goggle, which is fixed on a frame or a side clip on either side of a goggle. The diver presses a button on top of the luminous device, for lighting purposes, and particularly for diving partners to clearly notice the divers' position. Moreover, the bright light does not have an effect on divers' eyes, thus will not cause dizziness from diving.

### BACKGROUND OF INVENTION

a) Field of the Invention

The present invention relates to a luminous device installed on a goggle frame or a side clip on either side, particularly for diving partners on both sides to clearly notice the diver's position, other than providing lighting purposes.

b) Description of the Prior Art

The conventional luminous device on a goggle, as in U.S. Pat. No. 5,622,422, U.S. Pat. No. 5,553,606 and U.S. Pat. No. 5,701,884, is mostly installed on an upper hood of the goggle, or on a snorkel. The structure is more focused on a light bulb or LED lighting function, less focused on its waterproof function, thus due to the simplicity of structure, water often enters the luminous device, causing malfunction. Furthermore, the luminous device installed on the upper hood of the goggle having bright light causes eye irritation, and may cause dizziness in the long term.

### SUMMARY OF THE INVENTION

The object of the invention is to provide a luminous device installed on a goggle frame or a side clip on either side, particularly to protect the diver's eyes from the bright light, further allowing diving partners on both sides to clearly notice the diver's position. Moreover, the waterproof function of lighting monitor prevents water from entering into the luminous device.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a perspective schematic view in accordance with the invention.

FIG. 2 is an exploded perspective schematic view in accordance with the present invention.

FIG. 3 is a cross-sectional schematic view of the invention.

FIG. 4 is a perspective schematic view illustrating the luminous device being installed on a frame.

FIG. 5 is a perspective schematic view illustrating the luminous device being installed on a side clip.

### DETAILED DESCRIPTION OF THE PREFFERED EMBODIMENTS

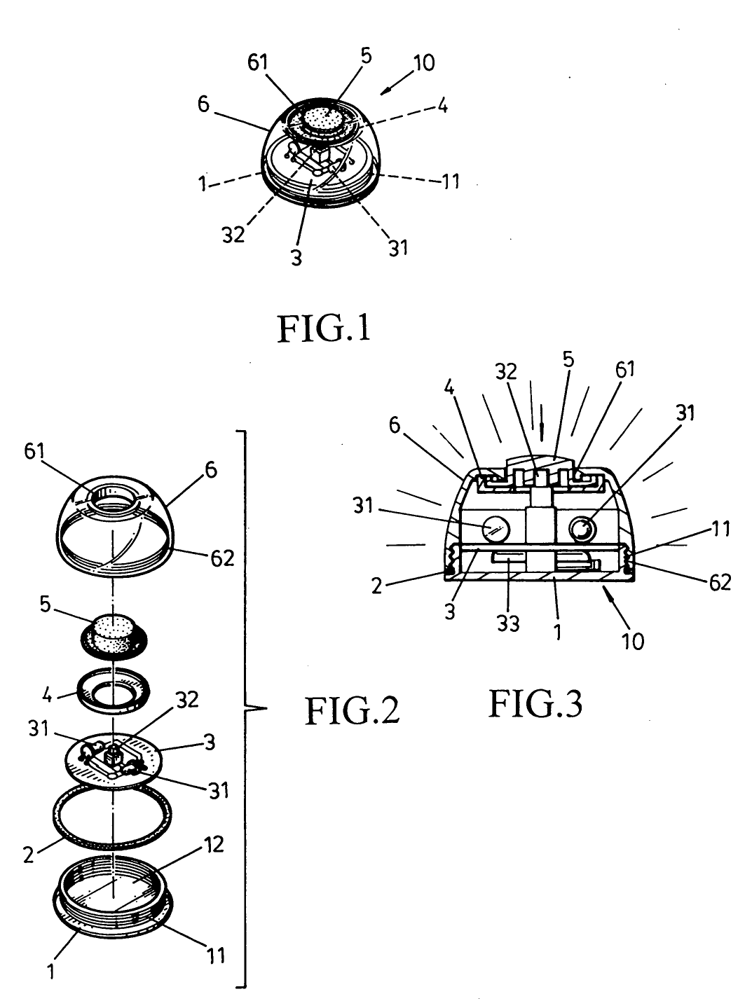

With reference to FIG. 1 to 2, a luminous device of the present invention mainly consists of a base seat 1, a waterproof sealing 2, a circuit board 3, a ring plate 4, a button 5, and a top cover 6. The base seat 1 has an external thread 11 on its outer ring whereby allowing the waterproof sealing 2 to be inserted, wherein a circular socket 12 formed by the base seat 1 on top of the waterproof sealing 2 allowing insertion of a circuit board 3. Two LED's (Light Emitting Diode) and a switch 32 is assembled on an upper side of the circuit board 3, whereas on an under side, a battery 33 (FIG. 3) is installed. The ring plate 4 is situated on top of the circuit board. A soft, rubber-like button 5 is established on the ring plate 4. A top portion of the button 5 is protruding out of the top cover 6, through the circular aperture 61. The transparent plastic top cover 6 completely covers the circuit board 3. An internal thread 62 formed at a base of the top cover 6 screws tightly with the external thread 11 at the top of the base seat 1. Furthermore, the ring plate 4 is sealed tightly together with the top cover 6 by means of mechanical heat compression to prevent water from entering into the luminous device. When the button 5 is pressed downwards, it will come in contact with the switch 32 on the circuit board 3, enabling the LED 31 to emit light; when the button 5 is pressed again, the LED 31 will no longer emit light.

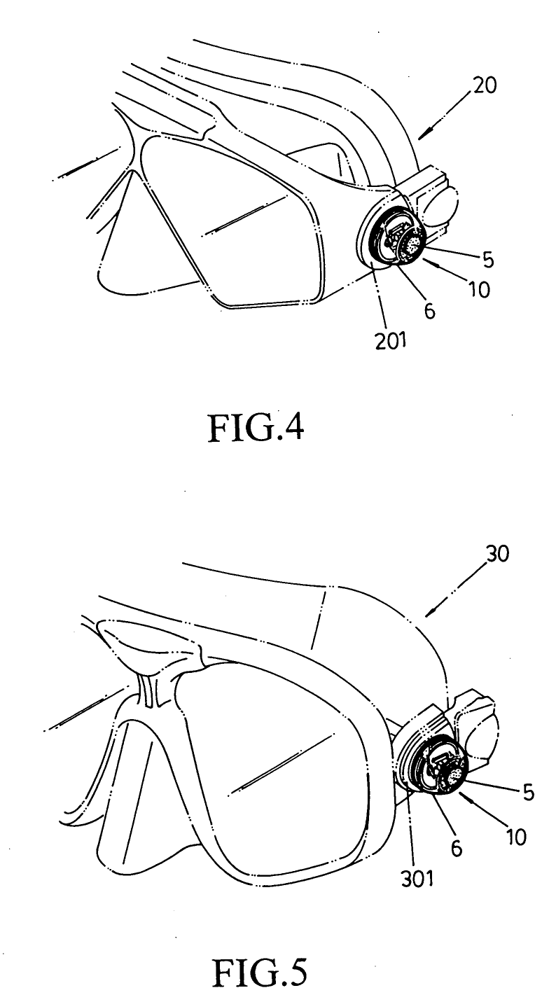

The luminous device 10 is fixed on a frame 201 (FIG. 4) or on a side clip (FIG. 5) on either side of a goggle 20, as shown in the embodiment of goggle 20 and 30.

1. A luminous device installed on a goggle frame comprising:
a base seat with external thread forming on an outer ring, having a circular socket wherein a waterproof sealing is assembled on the base seat; a circuit board with a LED and a switch installed on top is situated in the circular socket; a battery is installed at an underside of the circuit board; a ring plate is established on top of the circuit board having a button inserted therein; a top cover having internal thread on a lower portion screws tightly with the external thread of the base seat; a circular opening formed at an upper end of the top cover allowing the button to protrude thereby enabling waterproof effect.

2. The luminous device of a goggle in accordance with claim 1, the luminous device is installed on a side clip on either side thereof.
